(19) United States
(12) Patent Application Publication
(10) Pub. No.: US 2024/0230336 A9
(43) Pub. Date: Jul. 11, 2024

(54) ROUTE PLANNING FOR UNMANNED AERIAL VEHICLES

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US)

(21) Appl. No.: 17/009,873

(22) Filed: Sep. 2, 2020

Related U.S. Application Data
(60) Provisional application No. 62/909,928, filed on Oct. 3, 2019.
(60) Provisional application No. 62/894,887, filed on Sep. 2, 2019.

(51) Int. Cl. G08G 5/00

(52) U.S. Cl. CPC G08G 5/006; G08G 5/0013; G08G 5/0039; G08G 5/0069

(57) ABSTRACT

Route planning for an unmanned aerial vehicle (UAV) is disclosed. A map of a region is partitioned into geographic cells, data about flight conditions in each cell is aggregated, and a cost for each cell is calculated based on weighted flight condition factors. A plurality of flight paths from a first point to a second point are determined, and a cost for each flight path is determined by summing the cost of each cell traversed by the flight path. An optimal flight path is selected from the plurality of flight paths in dependence upon the total cost of each flight path. When new information is obtained that affects the cost of the cells the flight path, the cost of the current flight path is recalculated along with the costs of alternative flight paths to determine whether a route should be altered.

### CROSS-REFERENCE TO RELATED APPLICATIONS

This application is a non-provisional application for patent entitled to a filing date and claiming the benefit of earlier-filed U.S. Provisional Patent Application Ser. No. 62/894,887, filed Sep. 2, 2019, and U.S. Provisional Patent Application Ser. No. 62/909,928, filed Oct. 3, 2019.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to ensure to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

In a particular implementation, a method of route planning for a UAV is disclosed. In this implementation, the method includes partitioning, at the UAV, a map of a region into geographic cells, calculating a cost for each geographic cell, wherein the cost is a sum of a plurality of weighted factors. The method also includes determining, at the UAV, a plurality of flight paths for the UAV from a first location on the map to a second location on the map, wherein each flight path traverses a set of geographic cells. In this implementation, the method also includes determining, at the UAV, a cost for each flight path based on the total cost of the set of geographic cells traversed, and selecting, in dependence upon the total cost of each flight path, an optimal flight path from the plurality of flight paths. The UAV may include instructions that generate route information that store the parameters associated with the optimal flight path. The UAV may also include operating instructions that cause the UAV to fly in accordance with the flight path.

In another implementation, a control device for an unmanned aerial vehicle (UAV) is disclosed. The control device includes a processor and a memory storing instructions. In this implementation, the instructions are executable by the processor to partition a map of a region into geographic cells and calculate a cost for each geographic cell, wherein the cost is a sum of a plurality of weighted factors. The control device may also include instructions that are executable by the processor to determine a plurality of flight paths for the UAV from a first location on the map to a second location on the map, wherein each flight path traverses a set of geographic cells; determine a cost for each flight path based on the total cost of the set of geographic cells traversed; and select in dependence upon the total cost of each flight path, an optimal flight path from the plurality of flight paths. The control device may be configured to transmit this optimal flight path as route information to the UAV. In this particular implementation, the UAV may include operating instructions that cause the UAV to fly in accordance with the route information.

In a particular implementation, a non-transitory computer-readable medium is disclosed that stores instructions that, when executed by a processor, cause the processor to perform operations. In this implementation, the operations comprise partitioning a map of a region into geographic cells; calculating a cost for each geographic cell, wherein the cost is a sum of a plurality of weighted factors; determining a plurality of flight paths for the unmanned aerial vehicle (UAV) from a first location on the map to a second location on the map, wherein each flight path traverses a set of geographic cells; determining a cost for each flight path based on the total cost of the set of geographic cells traversed; and selecting in dependence upon the total cost of each flight path, an optimal flight path from the plurality of flight paths. The non-transitory computer-readable medium may also store instructions that when executed by the processor cause the processor to generate route information that stores the parameters of the selected optimal path. In this implementation, a computer executing the instructions in the computer-readable medium may also transmit the route information to a UAV and in response to receiving the route information, the UAV may fly in accordance with the route information.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for route planning of unmanned aerial vehicles;

FIG. 2 is a block diagram illustrating another implementation of a system for route planning of unmanned aerial vehicles;

FIG. 3 is a block diagram illustrating a particular implementation of blockchain-based operations used by the systems of FIGS. 1-2;

FIG. 4 is a flowchart to illustrate a particular implementation of a method for route planning of unmanned aerial vehicles;

FIG. 5 is an example flight path map used in route planning of unmanned aerial vehicles in accordance with the present disclosure;

FIG. 6 is a flowchart to illustrate another implementation of a method for route planning of unmanned aerial vehicles;

FIG. 7 is another example flight path map used in route planning of unmanned aerial vehicles in accordance with the present disclosure.

FIG. 8 is a flowchart to illustrate another implementation of a method for route planning of unmanned aerial vehicles;

FIG. 9 is a flowchart to illustrate another implementation of a method for route planning of unmanned aerial vehicles;

FIG. 10 is a flowchart to illustrate another implementation of a method for route planning of unmanned aerial vehicles; and

FIG. 11 is a flowchart to illustrate another implementation of a method for route planning of unmanned aerial vehicles.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

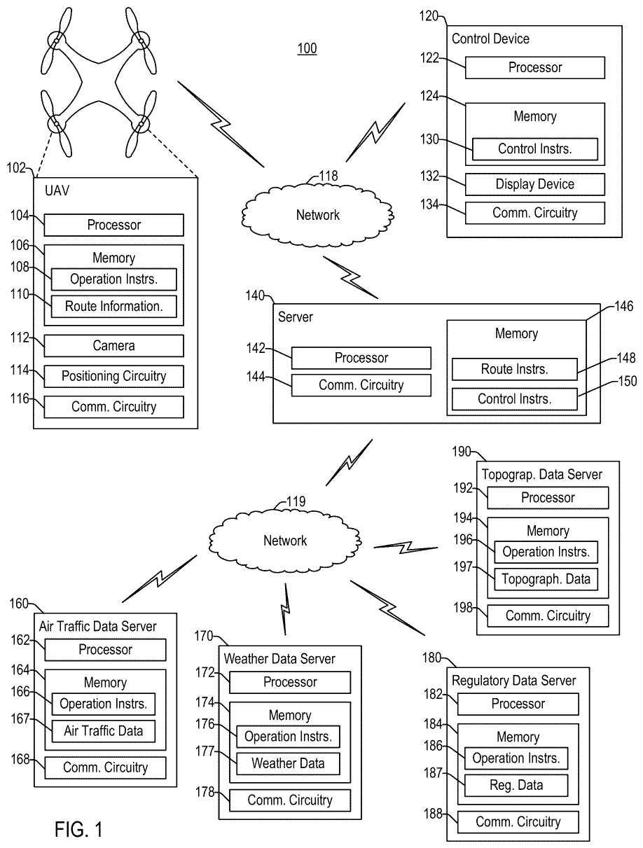

Exemplary methods, apparatuses, and computer program products for route planning for an UAV in accordance with the present invention are described with reference to the accompanying drawings, beginning with FIG. 1. FIG. 1 sets forth a diagram of a system (100) configured for route planning for an UAV according to embodiments of the present disclosure. The system (100) of FIG. 1 includes an unmanned aerial vehicle (UAV) (102), a control device (120), a server (140), an air traffic data server (160), a weather data server (170), a regulatory data server (180), and a topographical data server (190).

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such passenger drones (drone taxi, flying taxi, or pilotless helicopter) carry human passengers.

For ease of illustration, the UAV (102) is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV (102) includes a processor (104) coupled to a memory (106), a camera (112), positioning circuitry (114), and communication circuitry (116). The communication circuitry (116) includes a transmitter and a receiver or a combination thereof (e.g., a transceiver). In a particular implementation, the communication circuitry (116) (or the processor (104)) is configured to encrypt outgoing message(s) using a private key associated with the UAV (102) and to decrypt incoming message(s) using a public key of a device (e.g., the control device (120) or the server (140)) that sent the incoming message(s). Thus, in this implementation, communications between the UAV (102), the control device (120), and the server (140) are secure and trustworthy (e.g., authenticated).

The camera (112) is configured to capture image(s), video, or both, and can be used as part of a computer vision system. For example, the camera (112) may capture images or video and provide the video or images to a pilot of the UAV (102) to aid with navigation. Additionally, or alternatively, the camera (112) may be configured to capture images or video to be used by the processor (104) during performance of one or more operations, such as a landing operation, a takeoff operation, or object/collision avoidance, as non-limiting examples. Although a single camera (112) is shown in FIG. 1, in alternative implementations more and/or different sensors may be used (e.g., infrared, LIDAR, SONAR, etc.).

The positioning circuitry (114) is configured to determine a position of the UAV (102) before, during, and/or after flight. For example, the positioning circuitry (114) may include a global positioning system (GPS) interface or sensor that determines GPS coordinates of the UAV (102). The positioning circuitry (114) may also include gyroscope(s), accelerometer(s), pressure sensor(s), other sensors, or a combination thereof, that may be used to determine the position of the UAV (102).

The processor (104) is configured to execute instructions stored in and retrieved from the memory (106) to perform various operations. For example, the instructions include operation instructions (108) that include instructions or code that cause the UAV (102) to perform flight control operations. The flight control operations may include any operations associated with causing the UAV to fly from an origin to a destination. For example, the flight control operations may include operations to cause the UAV to fly along a designated route (e.g., based on route information (110), as further described herein), to perform operations based on control data received from one or more control devices, to take off, land, hover, change altitude, change pitch/yaw/roll angles, or any other flight-related operations. The UAV (102) may include one or more actuators, such as one or more flight control actuators, one or more thrust actuators, etc., and execution of the operation instructions (108) may cause the processor (104) to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The memory (106) also includes route information (110) that indicates a flight path for the UAV (102) to follow. For example, the route information (110) may specify a starting point (e.g., an origin) and an ending point (e.g., a destination) for the UAV (102). Additionally, the route information may also indicate a plurality of waypoints, zones, areas, regions between the starting point and the ending point.

The route information (110) may also indicate a corresponding set of control devices for various points, zones, regions, areas of the flight path. The indicated sets of control devices may be associated with a pilot (and optionally one or more backup pilots) assigned to have control over the UAV (102) while the UAV (102) is in each zone. The route information (110) may also indicate time periods during which the UAV is scheduled to be in each of the zones (and thus time periods assigned to each pilot or set of pilots).

The control device (120) includes a processor (122) coupled to a memory (124), a display device (132), and communication circuitry (134). The display device (132) may be a liquid crystal display (LCD) screen, a touch screen, another type of display device, or a combination thereof. The communication circuitry (134) includes a transmitter and a receiver or a combination thereof (e.g., a transceiver). In a particular implementation, the communication circuitry (134) (or the processor (122)) is configured to encrypt outgoing message(s) using a private key associated with the control device (120) and to decrypt incoming message(s) using a public key of a device (e.g., the UAV (102) or the server (140)) that sent the incoming message(s). Thus, in this implementation, communication between the UAV (102), the control device (120), and the server (140) are secure and trustworthy (e.g., authenticated).

The processor (122) is configured to execute instructions from the memory (124) to perform various operations. The instructions also include control instructions (130) that include instructions or code that cause the control device (120) to generate control data to transmit to the UAV (102) to enable the control device (120) to control one or more operations of the UAV (102) during a particular time period, as further described herein.

The server (140) includes a processor (142) coupled to a memory (146), and communication circuitry (144). The communication circuitry (144) includes a transmitter and a receiver or a combination thereof (e.g., a transceiver). In a particular implementation, the communication circuitry (144) (or the processor (142)) is configured to encrypt outgoing message(s) using a private key associated with the server (140) and to decrypt incoming message(s) using a public key of a device (e.g., the UAV (102) or the control device (120)) that sent the incoming message(s). Thus, in this implementation, communication between the UAV (102), the control device (120), and the server (140) are secure and trustworthy (e.g., authenticated).

The processor (142) is configured to execute instructions from the memory (146) to perform various operations. The instructions include route instructions (148) comprising computer program instructions for aggregating data from disparate data servers, virtualizing the data in a map, generating a cost model for paths traversed in the map, and autonomously selecting the optimal route for the UAV based on the cost model. For example, the route instructions (148) are configure to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions (148) are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions (148) may also include instructions for storing the parameters of the selected optimal flight path as route information (110). For example, the route information may include waypoints marked by GPS coordinates, arrival times for waypoints, pilot assignments. The server (140) may be configured to transmit the route information (110) to the UAV (102).

The instructions may also include control instructions (150) that include instructions or code that cause the server (140) to generate control data to transmit to the UAV (102) to enable the server (140) to control one or more operations of the UAV (102) during a particular time period, as further described herein.

The UAV (102), the control device (120), and server (140) are communicatively coupled via a network (118). For example, the network (118) may include a satellite network or another type of network that enables wireless communication between the UAV (102), the control device (120), and the server (140). In an alternative implementation, the control device (120), the server (140) communicate with the UAV (102) via separate networks (e.g., separate short range networks.

In some situations, minimal (or no) manual control of the UAV (102) may be performed, and the UAV (102) may travel from the origin to the destination without incident. However, in some situations, one or more pilots may control the UAV (102) during a time period, such as to perform object avoidance or to compensate for an improper UAV operation. In some situations, the UAV (102) may be temporarily stopped, such as during an emergency condition, for recharging, for refueling, to avoid adverse weather conditions, responsive to one or more status indicators from the UAV (102), etc. In some implementations, due to the unscheduled stop, the route information (110) may be updated (e.g., via a subsequent blockchain entry, as further described herein) by route instructions (148) executing on the UAV (102), the control device (120), or the server (140)). The updated route information may include updated waypoints, updated time periods, and updated pilot assignments.

In a particular implementation, the route information is exchanged using a blockchain data structure. The blockchain data structure is shared in a distributed manner across a plurality of devices of the system (100), such as the UAV (102), the control device (120), the server (140), and any other control devices or UAVs in the system (100). In a particular implementation, each of the devices of the system (100) stores an instance of the blockchain data structure in a local memory of the respective device. In other implementations, each of the devices of the system (100) stores a portion of the shared blockchain data structure and each portion is replicated across multiple of the devices of the system (100) in a manner that maintains security of the shared blockchain data structure as a public (i.e., available to other devices) and incorruptible (or tamper evident) ledger.

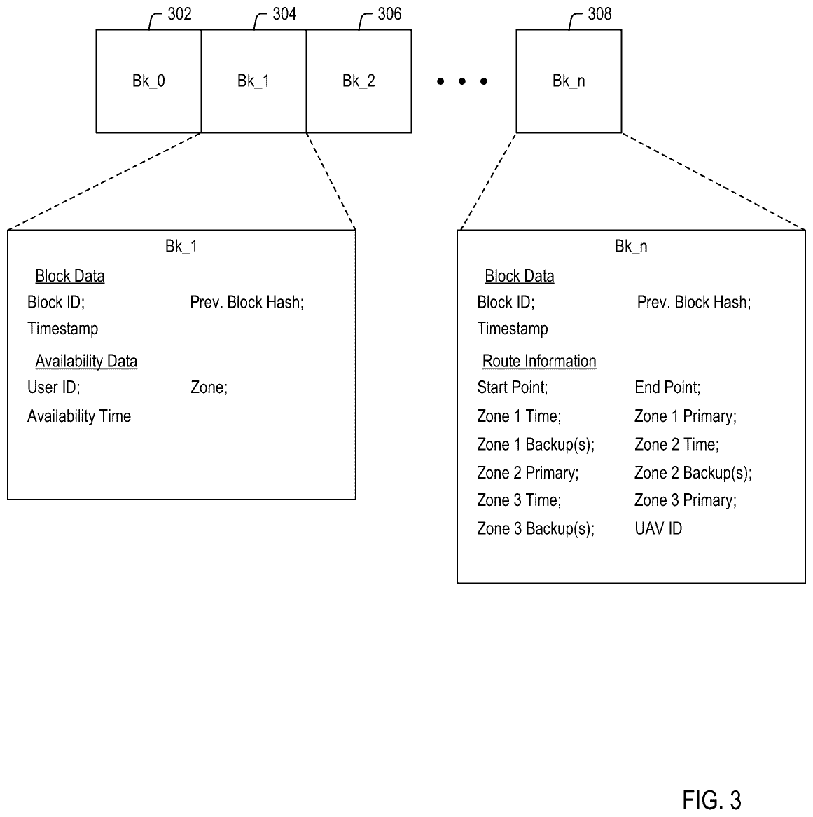

The blockchain data structure may include, among other things, route information associated with the UAV (102). For example, the route information (110) may be used to generate blocks of the blockchain data structure. A sample blockchain data structure (300) is illustrated in FIG. 3. Each block of the blockchain data structure (300) includes block data and other data, such as availability data or route data.

The block data of each block includes information that identifies the block (e.g., a block ID) and enables the devices of the system (100) to confirm the integrity of the blockchain data structure (300). For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3, the blockchain data structure (300) includes an initial block (Bk_0) (302) and several subsequent blocks, including a block Bk_1 (304), a block Bk_2 (306), and a block Bk_n (308). The initial block Bk_0 (302) includes an initial set of availability data or route data, a timestamp, and a hash value (e.g., a block ID) based on the initial set of availability data or route data. The block Bk_1 (304) also includes a hash value based on the other data of the block Bk_1 (304) and the previous hash value from the initial block Bk_0 (302). Similarly, the block Bk_2 (306) other data and a hash value based on the other data of the block Bk_2 (306) and the previous hash value from the block Bk_1 (304). The block Bk_n (308) includes other data and a hash value based on the other data of the block Bk_n (308) and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system (100).

In addition to the block data, each block of the blockchain data structure (300) includes availability data or route data. For example, the block Bk_1 (404) includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_n (408) includes route information that includes a UAV ID, a start point, an end point, waypoints, GPS coordinates, zone markings, time periods, primary pilot assignments, and backup pilot assignments for each zone associated with the route.

In a particular embodiment, the server (140) includes software that is configured to receive telemetry information from an airborne UAV and track the UAV's progress and status. The server (140) is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions (148) cause the server (140) to plan a flight path, generate route information, dynamically reroute the flight path and update the route information based on data aggregated from a plurality of data servers. For example, the server (140) may receive air traffic data (167) over the network (119) from an air traffic data server (160), weather data (177) from a weather data server (170), regulatory data (187) from a regulatory data server (180), and topographical data (197) from a topographic data server (190). It will be recognized by those of skill in the art that other data servers useful in-flight path planning of a UAV may also provide data to the server (140) over the network (101) or through direct communication with the server (140).

The air traffic data server (160) may include a processor (162), memory (164), and communication circuitry (168). The memory (164) of the air traffic data server (160) may include operating instructions (166) that when executed by the processor (162) cause the processor to provide the air traffic data (167) about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server (170) may include a processor (172), memory (174), and communication circuitry (178). The memory (174) of the weather data server (170) may include operating instructions (176) that when executed by the processor (172) cause the processor to provide weather data (177) about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server (180) may include a processor (182), memory (184), and communication circuitry (188). The memory (184) of the weather data server (180) may include operating instructions (186) that when executed by the processor (182) cause the processor provide regulatory data (187) about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server (190) may include a processor (192), memory (194), and communication circuitry (198). The memory (194) of the topographical data server (190) may include operating instructions (196) that when executed by the processor (192) cause the processor to provide topographical data about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server (140) may aggregate data from the data servers (160, 170, 180, 190) using application program interfaces (APIs), syndicated feeds and eXtensible Markup Language (XML), natural language processing, JavaScript Object Notation (JSON) servers, or combinations thereof. Updated data may be pushed to the server (140) or may be pulled on-demand by the server (140). Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server (140) can communicate with a UAV (102) using a variety of methods. For example, the UAV (102) may transmit and receive data using Cellular, 5G, Sub1 GHz, SigFox, WiFi networks, or any other communication means that would occur to one of skill in the art.

The network (119) may comprise one or more Local Area Networks (LANs), Wide Area Networks (WANs), cellular networks, satellite networks, internets, intranets, or other networks and combinations thereof. The network (119) may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

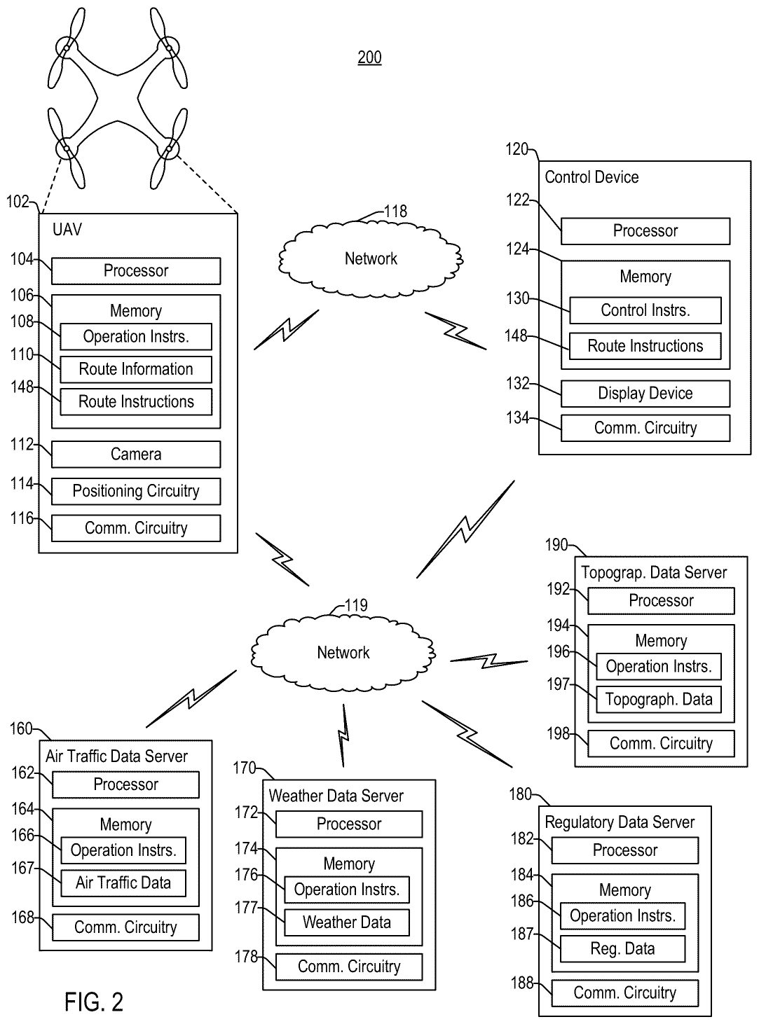

For further explanation, FIG. 2 sets forth a block diagram illustrating another implementation of a system (200) for route planning of unmanned aerial vehicles. Specifically, the system (200) of FIG. 2 shows an alternative configuration in which one or both of the UAV (102) and the server (140) may include route instructions (148) for generating route information. In this example, instead of relying on a server (140) to generate the route information, the UAV (102) and the control device (120) may retrieve and aggregate the information from the various data sources (e.g., the air traffic data server (160), the weather data server (170), the regulatory data server (180), and the topographical data server (190)). As explained in FIG. 1, the route instructions may be configured to use the aggregated information from the various source to plan and select a flight path for the UAV (102).

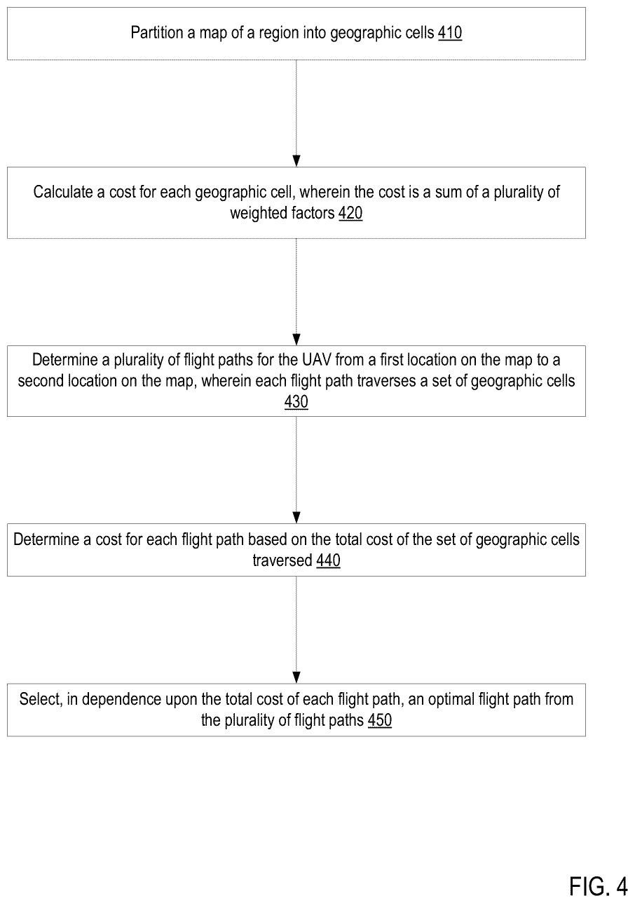

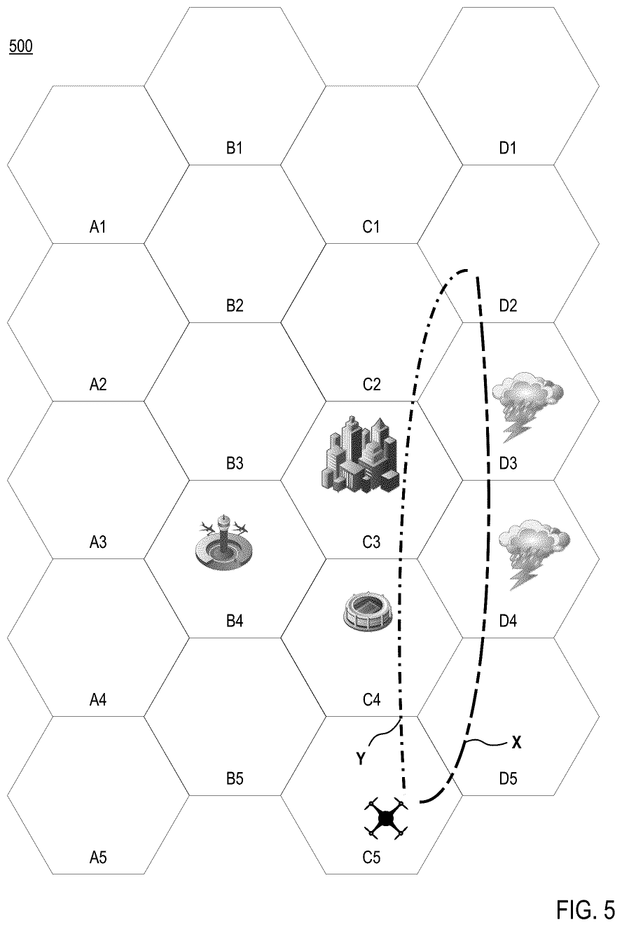

For further explanation, FIG. 4 sets forth a flow chart illustrating an exemplary method for route planning for a UAV according to embodiments of the present invention that comprises partitioning (410) a map of a region into geographic cells. Partitioning (410) a map of a region into geographic cells may be carried out by the route instructions (148) obtaining a map of the region to be traversed by the UAV, including a flight path from a first location to a second location. The first location may be an origin location or current location. The second location may be a destination location or a waypoint. Partitioning (410) a map of a region into geographic cells may be further carried out by the route instructions (148) overlaying a set of contiguous cells over the region, as shown in the exemplary map (500) of FIG. 5. Each geographic cell represents a geospatial boundary of fixed size. However, a geographic cell may be further subdivided into smaller geographic cells.

The method of FIG. 4 further comprises calculating (420) a cost for each geographic cell, wherein the cost is a sum of a plurality of weighted factors. Calculating (420) a cost for each geographic cell, wherein the cost is a sum of a plurality of weighted factors, may be carried out the route instructions (148) defining one or more factors that represent the relative difficulty of traversing a geographic cell and assigning weights to those factors. For example, an airspace factor may represent air traffic congestion and/or airspace restrictions that impose a difficulty on UAV navigation. An airspace factor may relate to a relative measure of airspace congestion or the difficulty of navigating through the airspace because of multiple intersecting flight paths of other UAVs or aircraft. Data used to derive airspace factors may be received from the airspace data server (150).

As another example, a weather factor may represent the severity of weather conditions that impose a difficulty on UAV navigation. A weather factor may include numerous factors such as high winds, rain, lightening, and other types of weather that affect the flight of a UAV. Weather factors may include relative measures of adverse weather conditions or raw weather data. Data used to derive weather factors may be received from the weather data server (160).

As another example, a topographic factor may represent the difficulty imposed by structures and terrain on a UAV's navigation through geographic cell. A topographic factor may relate to a relative measure of whether a cell is rural or urban, sparsely populated or densely populated, flat or mountainous, undeveloped or containing numerous structures. Mountainous areas, coastal areas, or cities with numerous high-rise buildings may have wind dynamics that are difficult to predict and thus impose greater difficulty to UAV navigation than, for example, a flat rural area. Data used to derive the topographic factors may be received from the topographic data server (180).

As yet another example, a particular geographic cell may fall within a restricted airspace, through which a UAV is not permitted to fly. By way of example and not limitation, a military base may have a restricted airspace that is a no-fly zone for non-military aircraft, an airport may have an airspace that is restricted for specific types of UAVs, municipalities may have regulations against UAVs at certain altitudes, an temporary airspace restrictions may be placed in an area hosting a special event, e.g., a diplomatic summit or major sporting event.

As one example, the airspace factor may impact navigability of the UAV more than the weather factor. That is, a UAV may be better equipped to handle inclement weather than to navigate in a congested field. Accordingly, in this example, the airspace factor is weighted more than the weather factor and contributes more to the cost of the cell. Further, the weather factor may impact navigability of the UAV more than the topographic factor. Accordingly, in this example, the weather factor is weighted more than the topographic factor and contributes more to the cost of the cell. Still further, a regulatory restriction such as a no-fly zone might outweigh all other factors and impose a very high cost on the cell. Continuing with this example, FIG. 5 illustrates a map (500) partitioned into geographical cell indicated by row and column, e.g., A1, B1, C1, etc. For ease of explanation, the partitioning of map (500) has been simplified, and a higher granularity of partitioning can be used for a more detailed cost model. In this example, cell B4 includes airport congestion as an airspace factor, cells C4 and D4 include thunderstorms as a weather factor, and cell C3 includes urban high-rise buildings as a topographic factor. Let it be assumed that airspace factors are attributed a weight A=7, weather factors are attributed a weight W=5, topographic factors are attributed a weight T=3, and regulatory factors are attributed a weight R=10. Based on only the above-identified factors, and in view of the exemplary weighting of these factors, cell B4 has a higher cost (i.e., 7) on navigability than cells C4 and D4 (i.e., 5), and cells C4 and D4 have a higher cost on navigability than cell C3 (i.e., 3).

The method of FIG. 4 further comprises determining (430) a plurality of flight paths for the UAV from a first location on the map to a second location on the map, wherein each flight path traverses a set of geographic cells. Determining (430) a plurality of flight paths for the UAV from a first location on the map to a second location on the map, wherein each flight path traverses a set of geographic cells, may be carried out by the AI route planning module (175) calculating the shortest distance flight path, then the next shortest distance flight path, and so on. A maximum distance may be set to limit the number of calculations and because a UAV implicitly has a limited range of flight due to battery consumption.

For example, using the map (500) of FIG. 5, assume that a first location is the current location of the UAV in cell C5 and assume that the second location is the destination in cell D2. For simplicity, consider that two paths that traverse only 4 cells, as no path traverses less than 4 cell borders. In the map (500) of FIG. 5, the first path X traverse cells D5, D4, D3, and D2 consecutively. The second path Y traverses cells C4, C3, C2, and D2 consecutively.

The method of FIG. 4 further comprises determining (440) a cost for each flight path based on the total cost of the set of geographic cells traversed. Determining (440) a cost for each flight path based on the total cost of the set of geographic cells traversed may be carried out by the route instructions (148) summing the cost of each cell in the flight path. Continuing the above example, assume the following cell costs in the map (500) of FIG. 5:

B4=7 a.

C3=3 b.

D3=5 c.

D4=5 d.

Further, assume all remaining cells have a nominal cost of 1, which may also include a distance cost. Given the cell costs above, the cost of flight paths X and Y are as follows:

X=D5+D4+D3+D2=1+5+5+1=12 e.

Y=C4+C3+C2+D2=1+3+1+1=6 f.

The method of FIG. 4 further comprises selecting (450), in dependence upon the total cost of each flight path, an optimal flight path from the plurality of flight paths. Selecting (450), in dependence upon the total cost of each flight path, an optimal flight path from the plurality of flight paths may be carried out by the route instructions (148) selecting the flight path with the lowest cost. When two flight paths have the same cost, the optimal flight path may also be dependent upon other factors, such as the shortest distance, the path most likely to be granted regulatory clearance, the safest flight path, and so on. Continuing the example map (500) of FIG. 5, the optimal flight path selected is flight path Y based on the lowest cost. The optimal flight path selected by the route instructions (148) in the server (140) may be then provided to the UAV via wireless transmission. Alternatively, the route instructions may be executed by the UAV (102) or the control device (120).

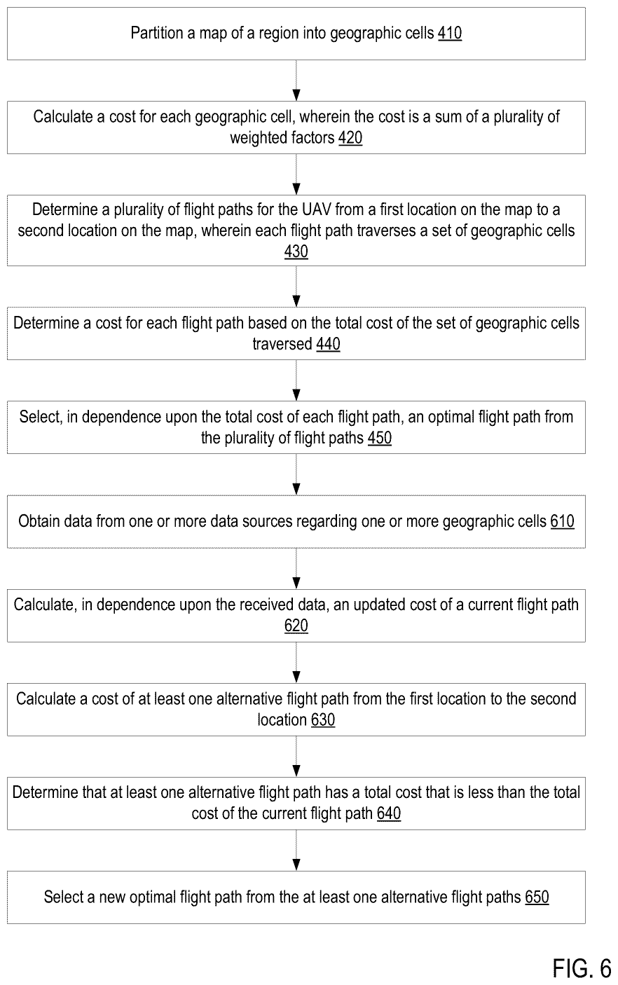

For further explanation, FIG. 6 sets forth a flow chart illustrating a further exemplary method for route planning for a UAV according to embodiments of the present invention. Like FIG. 4, FIG. 6 also includes partitioning (410) a map of a region into geographic cells, calculating (420) a cost for each geographic cell, wherein the cost is a sum of a plurality of weighted factors, determining (430) a plurality of flight paths for the UAV from a first location on the map to a second location on the map, wherein each flight path traverses a set of geographic cells, determining (440) a cost for each flight path based on the total cost of the set of geographic cells traversed, and selecting (450), in dependence upon the total cost of each flight path, an optimal flight path from the plurality of flight paths.

The method of FIG. 6 differs from FIG. 4 in that the method further comprises obtaining (610) data from one or more data servers regarding one or more geographic cells. Obtaining (610) data from one or more data servers regarding one or more geographic cells may be carried out by the server (140) receiving real-time data from data servers such as the airspace data server (160), the weather data server (170), the regulatory data server (180), and the topographic data server (190). For example, a stadium in cell C4 may be hosting a major sporting event prompting the FAA to issue a temporary airspace restriction while the UAV is in flight. In this example, the FAA is a regulatory data server (180) based on the type of information (i.e., airspace restriction) provided.

The method of FIG. 6 further differs from FIG. 4 in that the method further comprises calculating (620), in dependence upon the received data, an updated cost for each geographic cell traversed by a current flight path. Calculating (620), in dependence upon the received data, an updated cost for each geographic cell traversed by a current flight path may be carried out by identifying cells affected by the received data, determining whether the received data corresponds to a weighted factor, and recalculating the cost of the cell based on the new sum of the weighted factors. Continuing the above example, a regulatory factor carries a weight of 10. Thus, the new cost of cell C4 containing the stadium is R=10. The cost of flight path Y is now:

Y=C4+C3+C2+D2=10+3+1+1=15 g.

Accordingly, in the above example, flight path X now costs less than flight path Y.

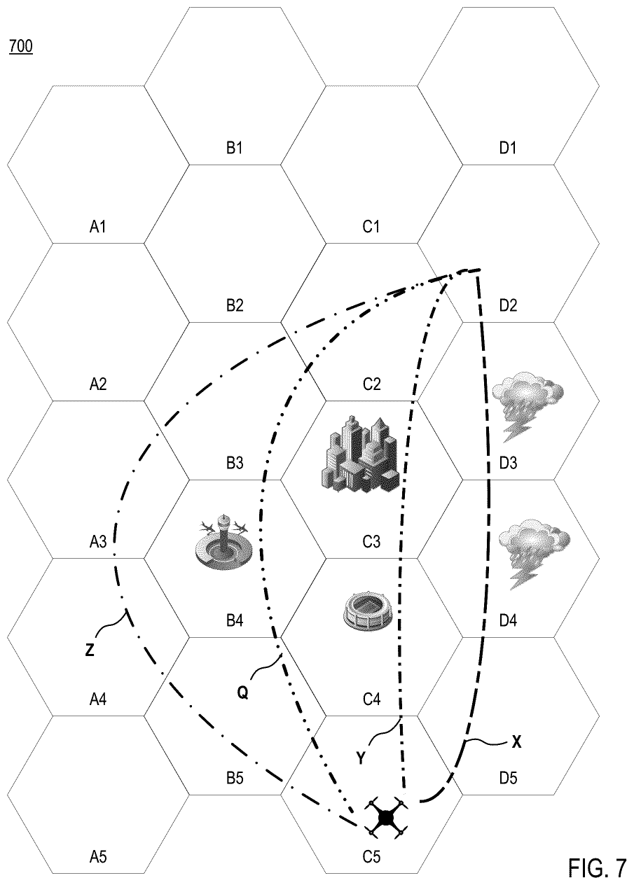

The method of FIG. 6 further differs from FIG. 4 in that the method further comprises calculating (630) a cost for each geographic cell traversed by at least one alternative flight path from the first location to the second location. Reference is now made to the map (700) FIG. 7, which is similar to the map (500) of FIG. 5, except that map (700) includes an exemplary alternative flight paths Q and Z. Flight path Q traverses cells B5, B4, B3, C2, and D2. The cost of flight path Q is thus:

Q=B5+B4+B3+C2+D2=1+7+1+1+1=11. h.

Accordingly, flight path Q costs less than flight path X. However, flight path Z traverses cells 5B, A4, A3, B3, C2, and D2, thus the cost of flight path Z is:

Z=5B+A4+A3+B3+C2+D2=1+1+1+1+1+1=6. i.

The method of FIG. 6 further differs from FIG. 4 in that the method further comprises determining (640) that at least one alternative flight path has a total cost that is less than the total cost of the current flight path. Determining (640) that at least one alternative flight path has a total cost that is less than the total cost of the current flight path may be carried out by summing the costs of all cell traversed by each alternative flight path and comparing the summed total cost of each alternative flight path to the recalculated cost of the current flight path. In this case, both flight paths Q and Z have a lower cost than the new cost of flight path Y.

The method of FIG. 6 further differs from FIG. 4 in that the method further comprises selecting (650) a new optimal flight path from the at least one alternative flight paths. Selecting (650) a new optimal flight path from the at least one alternative flight paths may be carried out by selecting the lowest cost flight path from the alternative flight paths. Continuing the above example, the new optimal flight path is flight path Z because it has the lowest cost.

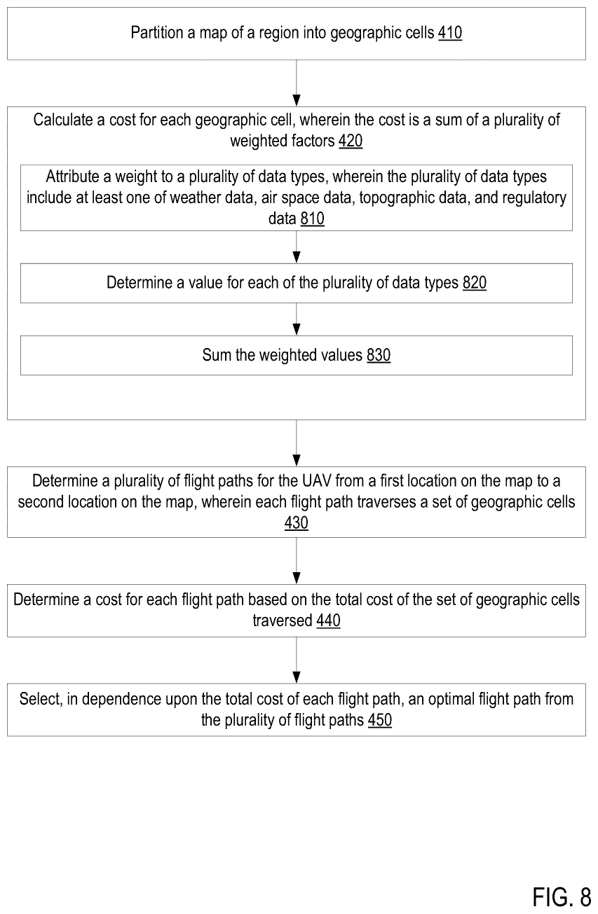

For further explanation, FIG. 8 sets forth a flow chart illustrating a further exemplary method for route planning for a UAV according to embodiments of the present invention. Like FIG. 4, FIG. 8 also includes partitioning (410) a map of a region into geographic cells, calculating (420) a cost for each geographic cell, wherein the cost is a sum of a plurality of weighted factors, determining (430) a plurality of flight paths for the UAV from a first location on the map to a second location on the map, wherein each flight path traverses a set of geographic cells, determining (440) a cost for each flight path based on the total cost of the set of geographic cells traversed, and selecting (450), in dependence upon the total cost of each flight path, an optimal flight path from the plurality of flight paths.

The method of FIG. 8 differs from the method of FIG. 4 in that calculating (420) a cost for each geographic cell, wherein the cost is a sum of a plurality of weighted factors, comprises attributing (810) a weight to a plurality of data types, wherein the plurality of data types include at least one of weather data, airspace data, topographic data, and regulatory data. The data types may arise from the substance of the data, such as weather data or terrain data, or the data type may arise from data servers, such as a weather data server (170) or a topographic data server (190).

The method of FIG. 8 further differs from the method of FIG. 4 in that calculating (420) a cost for each geographic cell, wherein the cost is a sum of a plurality of weighted factors, further comprises determining (820) a value for each of the plurality of data types. Determining (820) a value for each of the plurality of data types may be carried out by the route instructions (148) analyzing data received from each of the data servers (160, 170, 180, 190). Continuing the above examples, a geographic cell may have weighted factors such as some or all of an airspace cost, a weather cost, a topographic cost, and a regulatory cost, among others. The total cost of the cell may be total sum or weighted average of these costs. As with the previous examples, let it be assumed that airspace data is attributed a weight A=7, weather data is attributed a weight W=5, topographic data is attributed a weight T=3, and regulatory data is attributed a weight R=10.

Each weight multiplies a factor value indicating conditions in the geographic cell. In the above examples, a factor of “1” or “0” was used for simplicity to indicate, for example, the presence or absence airspace congestion, weather, etc. However, each factor itself represents the conditions in the cell as a numerical range. Airspace factors Fₐ may include a relative range of airspace congestion, for example, wherein 0 is the least congested and 9 is the most congested. Weather factors F_{w}, may include a relative measure of adverse weather conditions, wherein 0 is no adverse weather conditions and 9 is highly adverse weather conditions. Topographic factors Fₜ may include a relative measure difficulty imposed by the topography of the cell, wherein 0 is no difficulty and 9 is the most difficult topography to navigate. Regulatory factors Fᵣ may include a relative measure of difficulty imposed by regulations, laws and restrictions on navigation through a cell. Accordingly, a cost C of a cell may be calculated by:

C_{cell}=A(Fₐ)+W(F_{w})+T(Fₜ)+R(Fᵣ) j.

Readers of skill in the art will appreciate that different numerical ranges may be used, and a mixture of numerical ranges and Boolean values may also be used. Further, the conditions in a cell need not be modeled as precise representations, but rather as a worst-case prediction. In this manner, the route instructions (148) may determine a risk-averse route that maximizes safety. Readers of skill in the art will further appreciate that more than one fact of each data type may be used in calculating cost. For example, the severity of wind conditions and the severity of rain conditions may factor individually into cell cost.

The method of FIG. 8 further differs from the method of FIG. 4 in that calculating (420) a cost for each geographic cell, wherein the cost is a sum of a plurality of weighted factors, further comprises summing (830) the weighted values. In the example map (500), conditions in each geographic cell are represented by factor values. For example, cell B4 includes the airspace of an airport, thus an airspace factor value may be Fₐ=9 and a regulatory factor value may be Fᵣ=9 due to congestions and restrictions, whereas a weather factor value may be F_{w}=1 due to good weather and a topographic factor value may be Fₜ=0 due to flat, rural terrain. Using the above formula, the cost of cell B4 is:

C_{B4}=7(9)+5(1)+3(0)+10(9)=158 k.

By contrast, in the example map (500), cell A4 may have air traffic congestion rating, good weather, and flat terrain, such that Fₐ=2, F_{w}=1, Fₜ=0, and Fᵣ=0. Thus, the cost of cell A4 is:

C_{A4}=7(2)+5(1)+3(0)+10(0)=19 l.

Accordingly, it can be seen that the cost of traversing cell A4 is significantly smaller than the cost of traversing cell B4. Thus, the route instructions (148) may calculate the cost of cells B4 and A4 in determining a flight path, in that the UAV should divert away from cell B4 and travel through A4.

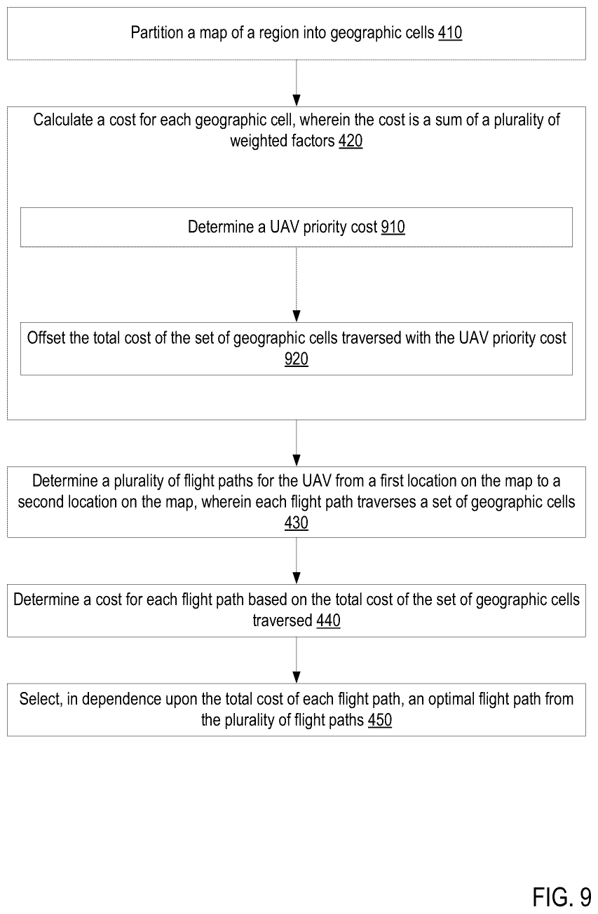

For further explanation, FIG. 9 sets forth a flow chart illustrating a further exemplary method for route planning for a UAV according to embodiments of the present invention. Like FIG. 4, FIG. 9 also includes partitioning (410) a map of a region into geographic cells, calculating (420) a cost for each geographic cell, wherein the cost is a sum of a plurality of weighted factors, determining (430) a plurality of flight paths for the UAV from a first location on the map to a second location on the map, wherein each flight path traverses a set of geographic cells, determining (440) a cost for each flight path based on the total cost of the set of geographic cells traversed, and selecting (450), in dependence upon the total cost of each flight path, an optimal flight path from the plurality of flight paths.

The method of FIG. 9 differs from the method of FIG. 4 in that determining (440) a cost for each flight path based on the total cost of the set of geographic cells traversed comprises determining (910) a UAV priority cost. Determining (910) a UAV priority cost may be carried out by the route instructions (148) assessing one or more UAV attributes that may justify or offset the cost of the flight path. For example, a UAV that is low on battery or carrying precious cargo may need to take the shortest distance route regardless of the costs imposed by the cells in that route. For example, a high UAV priority cost may arise from carrying human passengers, carrying living tissue cargo such as a donated organ for transplant, carrying a tissue sample for testing, or other types of precious cargo. A UAV priority cost may also arise from the monetary value of the cargo being transported, the sensitivity of the cargo to transport, a battery life or range of the UAV, or the necessity for UAV servicing, and so on.

The method of FIG. 9 further differs from the method of FIG. 4 in that determining (440) a cost for each flight path based on the total cost of the set of geographic cells traversed further comprises offsetting (920) the total cost of the set of geographic cells traversed with the UAV priority cost. Offsetting (920) the total cost of the set of geographic cells traversed with the UAV priority cost may be carried out by the route instructions (148) subtracting the calculated UAV priority cost from the flight path cost. Continuing the above examples in the map (700) of FIG. 7, flight path X in FIG. 7 has a total cost of 12. However, a UAV may be carrying precious cargo that requires the shortest reasonable flight possible. For example, a UAV carrying living tissue may be attributed a priority of 7. Thus, flight path X, which traverses four cells with a total cost of 12, may be offset with the UAV priority cost of 7 such that the adjusted cost of the flight path X is 5. The adjusted cost of flight path X is now lower than the cost of flight path Z.

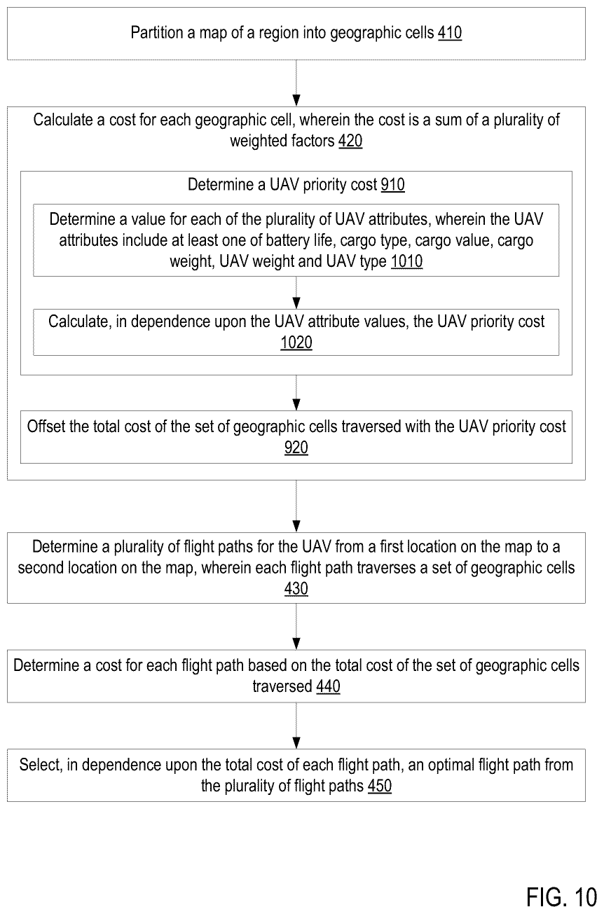

For further explanation, FIG. 10 sets forth a flow chart illustrating a further exemplary method for route planning for a UAV according to embodiments of the present invention. Like FIG. 9, FIG. 10 also includes partitioning (410) a map of a region into geographic cells, calculating (420) a cost for each geographic cell, wherein the cost is a sum of a plurality of weighted factors, determining (430) a plurality of flight paths for the UAV from a first location on the map to a second location on the map, wherein each flight path traverses a set of geographic cells, determining (440) a cost for each flight path based on the total cost of the set of geographic cells traversed, and selecting (450), in dependence upon the total cost of each flight path, an optimal flight path from the plurality of flight paths, wherein determining (440) a cost for each flight path based on the total cost of the set of geographic cells traversed comprises determining (910) a UAV priority cost and offsetting (920) the total cost of the set of geographic cells traversed with the UAV priority cost.

The method of FIG. 10 differs from the method of FIG. 9 in that determining (910) a UAV priority cost further comprises determining (1010) a value for each of the plurality of UAV attributes, wherein the UAV attributes include at least one of battery life, cargo type, cargo value, cargo weight, UAV weight and UAV type. Determining (1010) a value for each of the plurality of UAV attributes, wherein the UAV attributes include at least one of battery life, cargo type, cargo value, cargo weight, UAV weight and UAV type may be carried out by determining battery life from UAV telemetry, determining a cargo value, cargo weight, and cargo type from a UAV manifest, and determining UAV weight and UAV type from a UAV record.

The method of FIG. 10 further differs from the method of FIG. 9 in that determining (910) a UAV priority cost further comprises calculating, (1020) in dependence upon the UAV attribute values, the UAV priority cost. For example, a UAV may be a cargo type with a weight of 45 lbs. and a cargo weight of 5 lbs. Based on the battery life value and the total weight of 50 lbs., the UAV may have a remaining range of 2 miles. The UAV may also be carrying a cargo type that is precious cargo with a cargo value that is high. Accordingly, the UAV priority cost is calculated to have a relatively high priority cost. By contrast, a UAV may be cargo type UAV with a weight of 20 lbs. and a cargo weight of 2 lbs. Based on the battery life value and the total weight of 22 lbs., the UAV may have a remaining range of 10 miles, in excess of any projected flight path. The UAV may also be carrying a cargo type that is standard cargo with a cargo value that is low. Accordingly, the UAV priority cost is calculated to have a relatively low priority cost.

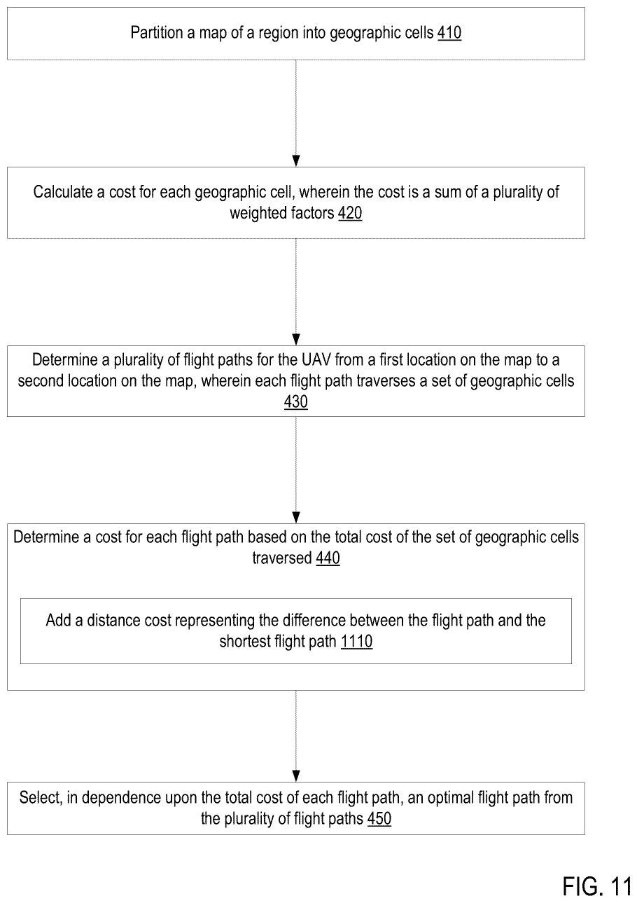

For further explanation, FIG. 11 sets forth a flow chart illustrating a further exemplary method for route planning for a UAV according to embodiments of the present invention. Like FIG. 4, FIG. 11 also includes partitioning (410) a map of a region into geographic cells, calculating (420) a cost for each geographic cell, wherein the cost is a sum of a plurality of weighted factors, determining (430) a plurality of flight paths for the UAV from a first location on the map to a second location on the map, wherein each flight path traverses a set of geographic cells, determining (440) a cost for each flight path based on the total cost of the set of geographic cells traversed, and selecting (450), in dependence upon the total cost of each flight path, an optimal flight path from the plurality of flight paths.

The method of FIG. 11 differs from the method of FIG. 4 in that determining (440) a cost for each flight path based on the total cost of the set of geographic cells traversed comprises adding (1110) a distance cost representing the difference between the flight path and the shortest flight path. In some situations, particularly where a UAV is low on battery life, the cost of adding extra distance in a flight path may be more detrimental than in other situations. For example, in the example map (700) of FIG. 7, flight path Z may add considerable distance over flight path X, despite the fact that flight path X includes cell costs attributable to adverse weather conditions. To compensate, adding (1110) a distance cost representing the difference between the flight path and the shortest flight path may be carried out by the route instructions (148) adding a distance cost to the flight path in addition to the cost of each cell traversed. To compensate, adding (1110) a distance cost representing the difference between the flight path and the shortest flight path may be carried out by adding a distance cost to each cell as part of the cell cost. Continuing the above examples, flight path Z travels through two additional cells compared to flight path X. If each cell is attributed a distance cost of 4, the adjusted cost of flight path Z=14, which is greater than the cost of flight path X=12.

In view of the explanations set forth above, readers will recognize that the benefits of route planning for UAVs according to embodiments of the present invention include route instructions aggregating large amounts of data and uses that data to intelligently plan and reroute the flight path of a UAV. It will be appreciated that the route instructions executing on devices enables safer and more efficient flight path navigation than could be provided by a human operator alone. The autonomous flight path adjustment provided by the route instructions described above quickly interprets real-time data about flight path conditions, makes intelligent decisions based on that real-time data affecting a UAV flight path, and reacts to the real-time data without the need for human intervention.

Exemplary embodiments of the present invention are described largely in the context of a fully functional computer system for route planning for a UAV. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method comprising:
identifying, at an unmanned aerial vehicle (UAV), a map of a region partitioned into geographic cells;
calculating, at the UAV, a single numerical cost for each geographic cell, wherein the cost is a sum of a plurality of weighted factors, wherein the plurality of weighted factors include airspace congestion, airspace restrictions, weather, and topography, and wherein each of the plurality of weighted factors is represented by a numerical value;
determining, at the UAV, a plurality of flight paths for the UAV from a first location on the map to a second location on the map, wherein each flight path traverses a set of geographic cells;
determining, at the UAV, a cost for each flight path based on a total cost of the set of geographic cells traversed; and
selecting, in dependence upon the total cost of each flight path, at the UAV, an optimal flight path from the plurality of flight paths.

2. The method of claim 1, further comprising:
obtaining, at the UAV, data from one or more data servers regarding one or more geographic cells;
calculating, in dependence upon the data, at the UAV, an updated cost for each geographic cell traversed by a current flight path;
calculating, at the UAV, a cost for each geographic cell traversed by at least one alternative flight path from the first location to the second location;
determining, at the UAV, that at least one alternative flight path has a total cost that is less than the total cost of the current flight path; and
selecting, at the UAV, a new optimal flight path from the at least one alternative flight paths.

3. The method of claim 1, wherein calculating a single numerical cost for each geographic cell includes:
attributing a first weight to an airspace congestion factor, a second weight to an airspace restriction factor, a third weight to a weather factor, and a fourth weight to a topography factor;
identifying a first numerical rating indicative of airspace congestion, a second numerical rating indicative of airspace restrictions, a third numerical rating indicative of weather conditions, and a fourth numerical rating indicative of topography;
weighting the first numerical rating in accordance with the first weight, the second numerical rating in accordance with the second weight, the third numerical rating in accordance with the third weight, and the fourth numerical rating in accordance with the fourth weight; and
determining a numerical sum of the weighted first numerical rating, the weighted second numerical rating, the weighted third numerical rating, and the weighted fourth numerical rating.

4. The method of claim 1, wherein determining a cost for each flight path based on the total cost of the set of geographic cells traversed includes:
determining an UAV priority cost based on at least a cargo of the UAV; and
offsetting the total cost of the set of geographic cells traversed with the UAV priority cost.

5. The method of claim 4, wherein determining the UAV priority cost includes:
determining a value for each of a plurality of UAV attributes, wherein the UAV attributes include at least one of battery life, cargo type, cargo value, cargo weight, UAV weight and UAV type; and
calculating, in dependence upon the UAV attribute values, the UAV priority cost.

6. The method of claim 1, wherein determining a cost for each flight path based on the total cost of the set of geographic cells traversed includes adding a distance cost representing a difference between the flight path and a shortest flight path.

7. (canceled)

8. A control device for an unmanned aerial vehicle (UAV),
the control device comprising:
a processor; and
a memory storing instructions, the instructions executable by the processor to:
identifying a map of a region partitioned into geographic cells;
calculate a single numerical cost for each geographic cell, wherein the cost is a sum of a plurality of weighted factors, wherein the plurality of weighted factors include airspace congestion, airspace restrictions, weather, and topography, and wherein each of the plurality of weighted factors is represented by a numerical value;
determine a plurality of flight paths for the UAV from a first location on the map to a second location on the map, wherein each flight path traverses a set of geographic cells;
determine a cost for each flight path based on a total cost of the set of geographic cells traversed; and
select in dependence upon the total cost of each flight path, an optimal flight path from the plurality of flight paths.

9. The control device of claim 8 wherein the instructions are further executable by the processor to:
generate route information indicating the selected optimal flight path; and
transmit to the UAV, the route information indicating the selected optimal flight path.

10. The control device of claim 8 wherein the instructions are further executable by the processor to:
obtain data from one or more data servers regarding one or more geographic cells;
calculate, in dependence upon the data, an updated cost for each geographic cell traversed by a current flight path;
calculate a cost for each geographic cell traversed by at least one alternative flight path from the first location to the second location;
determine that at least one alternative flight path has a total cost that is less than the total cost of the current flight path; and
select a new optimal flight path from the at least one alternative flight paths.

11. The control device of claim 8, wherein calculating a single numerical cost for each geographic cell includes:
attributing a first weight to an airspace congestion factor, a second weight to an airspace restriction factor, a third weight to a weather factor, and a fourth weight to a topography factor;
identifying a first numerical rating indicative of airspace congestion, a second numerical rating indicative of airspace restrictions, a third numerical rating indicative of weather conditions, and a fourth numerical rating indicative of topography;
weighting the first numerical rating in accordance with the first weight, the second numerical rating in accordance with the second weight, the third numerical rating in accordance with the third weight, and the fourth numerical rating in accordance with the fourth weight; and
determining a numerical sum of the weighted first numerical rating, the weighted second numerical rating, the weighted third numerical rating, and the weighted fourth numerical rating.

12. The control device of claim 8, wherein determining a cost for each flight path based on the total cost of the set of geographic cells traversed includes:
determining a UAV priority cost based on at least a cargo of the UAV; and
offsetting the total cost of the set of geographic cells traversed with the UAV priority cost.

13. The control device of claim 12, wherein determining the UAV priority cost includes:
determining a value for each of a plurality of UAV attributes, wherein the UAV attributes include at least one of battery life, cargo type, cargo value, cargo weight, UAV weight and UAV type; and
calculating, in dependence upon the UAV attribute values, the UAV priority cost.

14. The control device of claim 8, wherein determining a cost for each flight path based on the total cost of the set of geographic cells traversed includes adding a distance cost representing a difference between the flight path and a shortest flight path.

15. A non-transitory computer-readable medium storing instructions that, when executed by a processor, cause the processor to perform operations, the operations comprising:
identifying a map of a region partitioned into geographic cells;
calculating a single numerical cost for each geographic cell, wherein the cost is a sum of a plurality of weighted factors, wherein the plurality of weighted factors include airspace congestion, airspace restrictions, weather, and topography, and wherein each of the plurality of weighted factors is represented by a numerical value;
determining a plurality of flight paths for an unmanned aerial vehicle (UAV) from a first location on the map to a second location on the map, wherein each flight path traverses a set of geographic cells;
determining a cost for each flight path based on a total cost of the set of geographic cells traversed; and
selecting in dependence upon the total cost of each flight path, an optimal flight path from the plurality of flight paths.

16. The non-transitory computer-readable medium of claim 15 wherein the operations further comprise:
generating route information indicating the selected optimal flight path; and
transmitting to the UAV, the route information indicating the selected optimal flight path.

17. The non-transitory computer-readable medium of claim 15 wherein the operations further comprise:
obtaining data from one or more data servers regarding one or more geographic cells;
calculating, in dependence upon the data, an updated cost for each geographic cell traversed by a current flight path;
calculating a cost for each geographic cell traversed by at least one alternative flight path from the first location to the second location;
determining that at least one alternative flight path has a total cost that is less than the total cost of the current flight path; and
selecting a new optimal flight path from the at least one alternative flight paths.

18. The non-transitory computer-readable medium of claim 15, wherein calculating a cost for each geographic cell includes:
attributing a first weight to an airspace congestion factor, a second weight to an airspace restriction factor, a third weight to a weather factor, and a fourth weight to a topography factor;
identifying a first numerical rating indicative of airspace congestion, a second numerical rating indicative of airspace restrictions, a third numerical rating indicative of weather conditions, and a fourth numerical rating indicative of topography;
weighting the first numerical rating in accordance with the first weight, the second numerical rating in accordance with the second weight, the third numerical rating in accordance with the third weight, and the fourth numerical rating in accordance with the fourth weight; and
determining a numerical sum of the weighted first numerical rating, the weighted second numerical rating, the weighted third numerical rating, and the weighted fourth numerical rating.

19. The non-transitory computer-readable medium of claim 15, wherein determining a cost for each flight path based on the total cost of the set of geographic cells traversed includes:
determining a UAV priority cost based on at least a cargo of the UAV; and
offsetting the total cost of the set of geographic cells traversed with the UAV priority cost.

20. The non-transitory computer-readable medium of claim 19, wherein determining the UAV priority cost includes:
determining a value for each of a plurality of UAV attributes, wherein the UAV attributes include at least one of battery life, cargo type, cargo value, cargo weight, UAV weight and UAV type; and
calculating, in dependence upon the UAV attribute values, the UAV priority cost.
